(19) United States
(12) Patent Application Publication
(10) Pub. No.: US 2025/0181266 A1
(43) Pub. Date: Jun. 5, 2025

(54) ACCESS GRANULARITY REFRESH CONTROL

(71) Applicant: Rambus Inc., San Jose, CA (US)

(72) Inventors: Dongyun Lee, Sunnyvale, CA (US); John Eric Linstadt, Palo Alto, CA (US)

(21) Appl. No.: 18/962,815

(22) Filed: Nov. 27, 2024

Related U.S. Application Data
(60) Provisional application No. 63/604,756, filed on Nov. 30, 2023.

(51) Int. Cl. G06F 3/06

(52) U.S. Cl. CPC G06F 3/0655; G06F 3/0604; G06F 3/0673

(57) ABSTRACT

A system and method of operation in a dynamic random access memory (DRAM) device. The method includes receiving, by the DRAM device from a controller, a refresh type flag indicating a refresh procedure for refreshing one or more rows of a memory cell array of the DRAM device. The method includes storing the refresh type flag in refresh control circuitry of the DRAM device. The method includes performing the row refresh of the DRAM device according to the refresh type flag stored in the refresh control circuitry.

### RELATED APPLICATIONS

This application claims benefits of provisional U.S. Patent Application No. 63/604,756, filed on Nov. 30, 2023, which is herein incorporated by reference in its entirety.

### BACKGROUND

### Technical Field

The present disclosure relates generally to integrated circuit memory devices, controller devices, and memory systems. More specifically, the present disclosure relates to systems and methods for managing data refresh of a memory device per access-granularity to reduce the communication overhead and/or overall power consumption of a memory device.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the spirit and scope of the described embodiments.

FIG. 1 illustrates a block diagram of an example memory system, according to some embodiments;

FIG. 2 illustrates a block diagram of an example environment for access-granularity refresh control of a memory device to reduce the communication overhead and/or overall power consumption of the memory device, according to some embodiments;

FIG. 3 depicts an example timing diagram for conveying the refresh type flag to a DRAM 104, according to some embodiments;

FIG. 4 depicts an example timing diagram for conveying the refresh type flag to the DRAM 104 when sending write data, according to some embodiments;

FIG. 5 illustrates a block diagram of an example of the DRAM in FIG. 1, according to some embodiments;

FIG. 6 illustrates a block diagram of a local refresh control circuitry of the row address latch & decode of the DRAM in FIG. 1, according to some embodiments; and

FIG. 7 is a flow diagram depicting a method for managing data refresh of a memory device per access-granularity to reduce the communication overhead and/or overall power consumption of the memory device, according to some embodiments.

### DETAILED DESCRIPTION

Aspects of the present disclosure provide a mechanism for managing data refresh of a memory device per access-granularity to reduce the communication overhead and/or overall power consumption of the memory device (e.g., DRAM), according to some embodiments. As discussed in greater detail below, a memory controller sends a refresh type flag to a DRAM using either an Option 1 method or an Option 2 method, where the refresh type flag indicates the selected refresh procedure for refreshing one or more rows of a memory cell array of the DRAM. According to the Option 1 method, the memory controller embeds the refresh type flag in a data access command (e.g., read or write) and sends the data access command to the DRAM 104 via the command interface, also referred to as command/address (CA) lines. According to the Option 2 procedure, the memory controller sends the refresh type flag to the DRAM via one or more inputs that are separate from the command interface and during a burst time associated with the data access command. The one or more inputs may be, for example, a data mask input (DMI), a single-ended read data strobe signal (RDQS), or a differential RDQS that includes a true side (e.g., RDQS_t) and a complimentary side (RDQS_c). The DRAM locally stores the refresh type flag in refresh control circuitry (e.g., latches) of the DRAM. The DRAM performs the row refresh of the DRAM according to the refresh type flag stored in the refresh control circuitry.

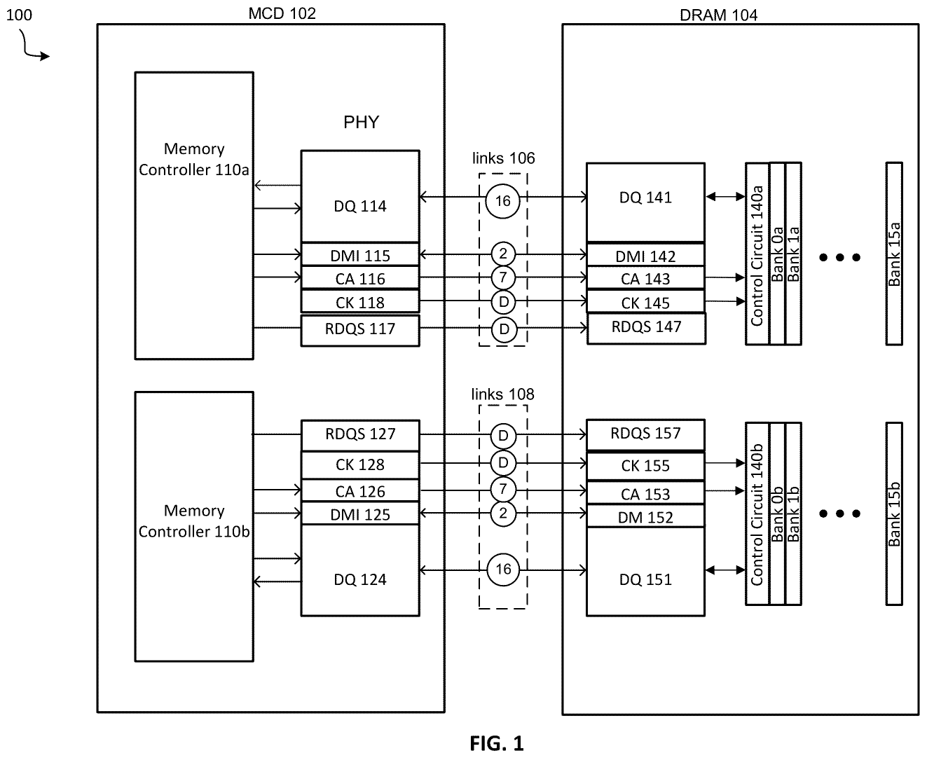

FIG. 1 illustrates a block diagram of an example memory system, according to some embodiments. The memory system 100 includes a memory controller device (MCD) 102 and a dual-channel dynamic random access memory device (DRAM) 104, according to an example embodiment. In some embodiments, the MCD 102 may be a stand-alone chip (e.g., an integrated circuit (IC)) that is separate from the DRAM 104, or the MCD 102 and the DRAM 104 may be disposed in the same package. The MCD 102 includes two sets of memory controllers, namely memory controller 110a and memory controller 110b (collectively referred to as, “memory controllers 110”).

Each of the memory controllers 110 include refresh-control circuitry that is configured to perform refresh management (RFM) for the DRAM 104 by scheduling a refresh (sometimes referred to as, “refresh events”) of the DRAM 104 and sending refresh commands to the DRAM 104 to cause the DRAM 104 to perform refresh operations.

The DRAM 104 includes two or more sets of memory banks, where each memory bank includes a plurality of memory cells. Each of the memory cells are configured to store a bit of data having a value of ‘0’ or ‘1’. The first set of memory banks includes Bank 0a, Bank 1a to Bank 15a (collectively referred to as, “Banks 0a-15a”). The second set of memory banks includes Bank 0b, Bank 1b, Bank 2b to Bank 15b (collectively referred to as, “Banks 0b-15b”).

The DRAM 104 includes a control circuit 140a that is respectively coupled to Banks 0a-15a and a control circuit 140b that is respectively coupled to Banks 0b-15b. The control circuit 140a may be configured to receive a refresh command from the memory controller 110a, via a command interface, and to perform a refresh of one or more cells of Banks 0a-15a according to the refresh command. The control circuit 140b may be configured to receive a refresh command from the memory controller 110b and to perform a refresh of one or more cells of Banks 0b-15b according to the refresh command. The DRAM 104 is considered a dual-channel DRAM because the components (e.g., memory controller 110a, control circuit 140a, etc.) of the first channel and the components (e.g., memory controller 110b, control circuit 140b, etc.) of the second channel operate independently from one another.

Each of the memory controllers 110 may be configured to communicate with the memory banks on DRAM 104 through a number of interfaces and communications links (e.g., Double Data Rate (DDR) command pins). More specifically, communications take place between memory controller 110a and the first set of memory banks (e.g., Banks 0a-15a) on DRAM 104 through (a) interfaces DQ 114 (e.g., DQ0 to DQ15), DMI 115, CA 116 (e.g., CA0 to CA6), CK 118 (differential), and read data strobe signal (RDQS) 117 on MCD 102; (b) links 106; and (c) interfaces DQ 141 (e.g., DQ0 to DQ15), DMI 142, CA6 143 (e.g., CA0 to CA6), CK 145 (differential), and RDQS 147 on DRAM 104. Similarly, communications take place between memory controller 110b and the second set of memory banks (e.g., Banks 0b-15) on DRAM 104 through (a) interfaces DQ 124 (e.g., DQ0 to DQ15), DMI 125, CA 126 (e.g., CA0 to CA6), CK 128 (differential), and RDQS 127 on MCD 102, (b) links 108, and (c) interfaces DQ 151 (e.g., DQ0 to DQ15), DMI 152, CA 153 (e.g., CA0 to CA6), CK 155, and RDQS 157 on DRAM 104. DMI 115 and DMI 125 are each multi-function pins that may be used for masking, byte inversion, or link parity.

The memory controller 110a may send one or more commands (e.g., read, write, refresh, etc.) to the first set of memory banks (e.g., Banks 0a-15a) and/or the control circuit 140a through CA 116 (sometimes collectively referred to as the “command interface” of MCD 102), links 106, and CA 143 (sometimes collectively referred to as the “command interface” of DRAM 104).

The memory controller 110b may send one or more commands to the second set of memory banks (e.g., Banks 0b-15b) and/or the control circuit 140b through CA 126 (sometimes collectively referred to as the “command interface” of MCD 102), links 108, and CA 153 (sometimes collectively referred to the “command interface” of DRAM 104).

The memory controller 110a may send/receive one or more sets of data to/from the first set of memory banks (e.g., Banks 0a-15a) and/or the control circuit 140a through DQ 114 (sometimes collectively referred to as, “a data interface” of MCD 102), links 106, and DQ 141 (sometimes collectively referred to as, “a data interface” of DRAM 104).

The memory controller 110b may send/receive one or more sets of data to/from the second set of memory banks (e.g., Banks 0b-15b) and/or the control circuit 140b through DQ 124 (sometimes collectively referred to as the “data interface” of MCD 102), links 108, and DQ 151 (sometimes collectively referred to as the “data interface” of DRAM 104).

Although the exemplary embodiment disclosed in FIG. 1 is a dual-channel DRAM that includes two sets of memory controllers 110, two sets of communication interfaces, two sets of control circuits 140, and two sets of memory banks, the same techniques can be applied to embodiments that use a single-channel DRAM that includes one memory controller 110, one set of communication interfaces, one control circuit 140, and one set of memory banks.

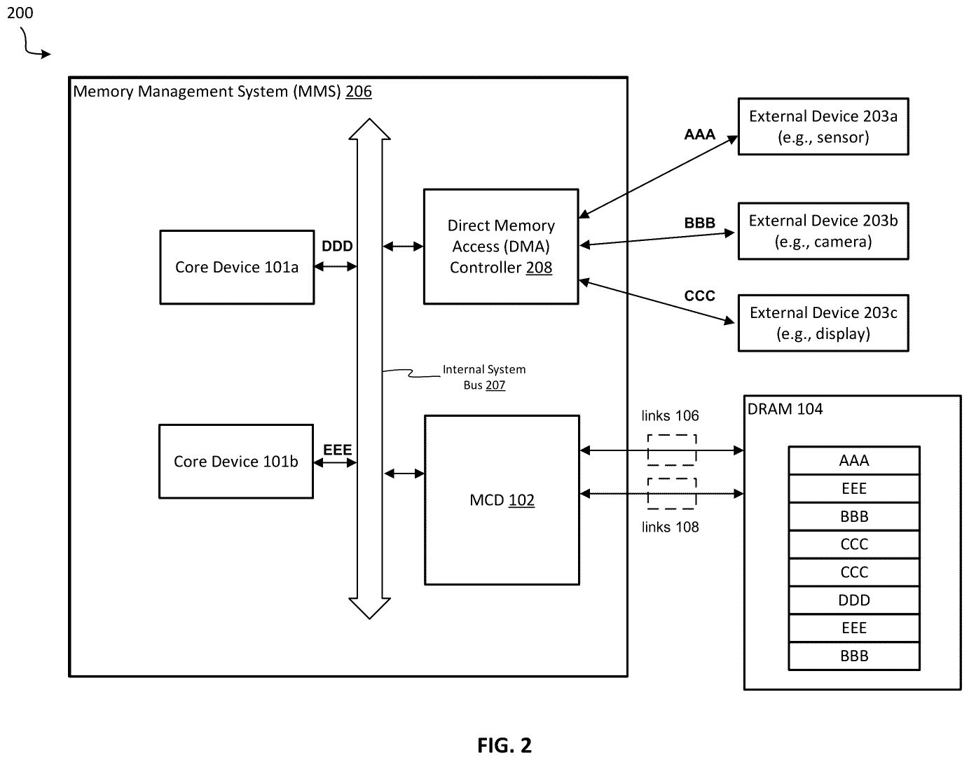

FIG. 2 illustrates a block diagram of an example environment for access-granularity refresh control of a memory device to reduce the communication overhead and/or overall power consumption of the memory device, according to some embodiments. The environment 200 includes a memory management system (MMS) 206, external devices 203 (e.g., external device 203a, external device 203b, external device 203c), the DRAM 104 in FIG. 1.

The MMS 206 includes the MCD 102 in FIG. 1, a direct memory access (DMA) device 208, and core devices 101 (e.g., core device 101a, core device 101b), which are each communicatively coupled together via an internal system bus 207 of the MMS 206. The internal system bus 207 may be configured to support any type of on-chip internal communication bus protocol including, for example, Advanced Microcontroller Bus Architecture (AMBA), Advanced/AMBA High-performance Bus (AHB), Advanced extensible Interface (AXI), or the like; thereby allowing each of the internal devices and components of the MMS 206 to communicate data/traffic with one another.

The MCD 102 is coupled to the DRAM 104 via link 106 and link 108 to facilitate the writing/reading of data to/from the DRAM 104. The MCD 102 may also use the links 106, 108 to send commands and/or signals to the DMI and RDQS pins of the DRAM 104. The DMA controller 208 is coupled to each of the external devices 203 via a dedicated communication bus for communicating traffic with the external devices 203a-203c.

An external device 203 may be any type of external device 203 that uses the DRAM 104 to provide a service, where each type of external device 203 demands a different type of usage (e.g., amount, layout) of the DRAM 104. For example, the external device 203a may be a sensor (e.g., a light sensor, an acoustic sensor, an accelerometer, a motion sensor, a temperature sensor, a proximity sensor, and the like) that demands a first type of usage of the DRAM 104. The external device 203b may be a camera (e.g., configured to capture photographs and record video) that demands a second type of usage of the DRAM 104. The external device 203c may be a display (e.g., Liquid Crystal Display (LCD), an Organic Light-Emitting Diode (OLED), Active-Matrix Organic Light-Emitting Diode (AMOLED), and the like) that demands a third type of usage of the DRAM 104.

Similarly, a core device 101 may be any type of core device of the MMS 206 that uses memory to provide a service. For example, a core device 101 may be a central processing device (CPU), a graphics processing units (GPU), a modem, and the like.

The core devices 101 send memory requests to the MMS 206 to demand a particular (and sometimes different) amount of memory resources of the DRAM 104 so to be able to effectively provide a particular service. Specifically, the external device 203a (e.g., a sensor) sends a memory request that includes a first dataset (e.g., AAA) to the DMA controller 208, which provides the first dataset to the MCD 102, which in turn, writes the first dataset to a single address location of the DRAM 104 using links 106 and/or links 108. The external device 203b (e.g., a camera) sends a memory request that includes a second dataset (e.g., BBB) to the DMA controller 208, which provides the second dataset to the MCD 102, which in turn, writes the second dataset to two address locations of the DRAM 104 using links 106 and/or links 108. The MCD 102 performs a read operation of a third dataset (e.g., CCC) from two address locations of the DRAM 104 using links 106 and/or links 108. The core device 201a sends a memory request that includes a fourth dataset (e.g., DDD) to the MCD 102, which in turn, writes the fourth dataset to a single address location of the DRAM 104 using links 106 and/or links 108. The core device 201a sends a memory access request that includes a fifth dataset (e.g., EEE) to the MCD 102, which in turn, writes the fifth dataset to two address locations of the DRAM 104 using links 106 and/or links 108.

Thus, the memory usage layout of the DRAM 104 is complicated by the different memory demands that are made by the different types of external devices 203 and core devices 101. This is shown in FIG. 2, where the BBB dataset is stored in two address locations that are separated by other address locations and the EEE dataset is stored in two address locations that are also separated by other address locations.

The MCD 102 manages the data refresh of the DRAM 104 on a per access-granularity to reduce the communication overhead on links 106, 108 and/or the overall power consumption of the MMS 206 and/or the DRAM 104. That is, the MCD 102 generates a data access command (e.g., a read command or a write command) that includes a refresh type flag. The refresh type flag indicates a particular refresh type/procedure for the DRAM 104 to use when performing a row refresh of its data. The refresh type flag indicates one of three refresh types/procedures: normal refresh, relaxed refresh, or no refresh. The MCD 102 selects the refresh procedure to include in the access command based on whether the refresh procedure would result in the greatest reduction in power consumption as compared to the estimated refresh performance of the other refresh procedures.

The MCD 102 may select the particular refresh procedure based on a current memory usage layout of the DRAM 104, the number and/or type of core devices 101 and external devices 203 that are communicating with the DMA controller 208, and/or the type of memory requests sent from the external devices 203. In some embodiments, the MCD 102 might select no refresh or a relaxed refresh instead of a normal refresh. For example, if the MCD 102 determines that a memory request has a short data lifetime (e.g., memory data for camera input and display buffer are required to stay less than 32 millisecond), then the MCD 102 selects no refresh. Alternatively, if the MCD 102 determines that data (e.g., big graph data in a recommendation engine, channel decoding, or image processing) has no or little impact with data errors, then the MCD 102 selects no refresh or relaxed refresh.

In an illustrative embodiment, the MCD 102 sends a refresh type flag to the DRAM 104, where the refresh type flag indicates the selected refresh procedure for refreshing one or more rows of a memory cell array of the DRAM 104. For example, the MCD 102 may implement an Option 1 method by embedding the refresh type flag in a data access command (e.g., read or write) and sending the data access command to the DRAM 104 via the command interface (e.g., CA 116, CA 126, etc.), or implement an Option 2 method by sending the refresh type flag to the DRAM 104 via one or more inputs (e.g., DMI, RDQS_t, RDQS_c) that are separate from the command interface and during a burst time associated with the data access command. The DRAM 104 locally stores the refresh type flag in refresh control circuitry of the DRAM 104. The DRAM 104 performs the row refresh of the DRAM 104 according to the refresh type flag that is associated with the row refresh address and stored in the refresh control circuitry. In some embodiments, the DRAM 104 may ignore a triggering event (e.g., a counter elapsing, a request from MCD 102) to perform a row refresh of the DRAM 104 if the refresh type flag indicates as such. In some embodiments, the DRAM may defer a row refresh of the DRAM 104 to a later moment in time if the refresh type flag indicates as such.

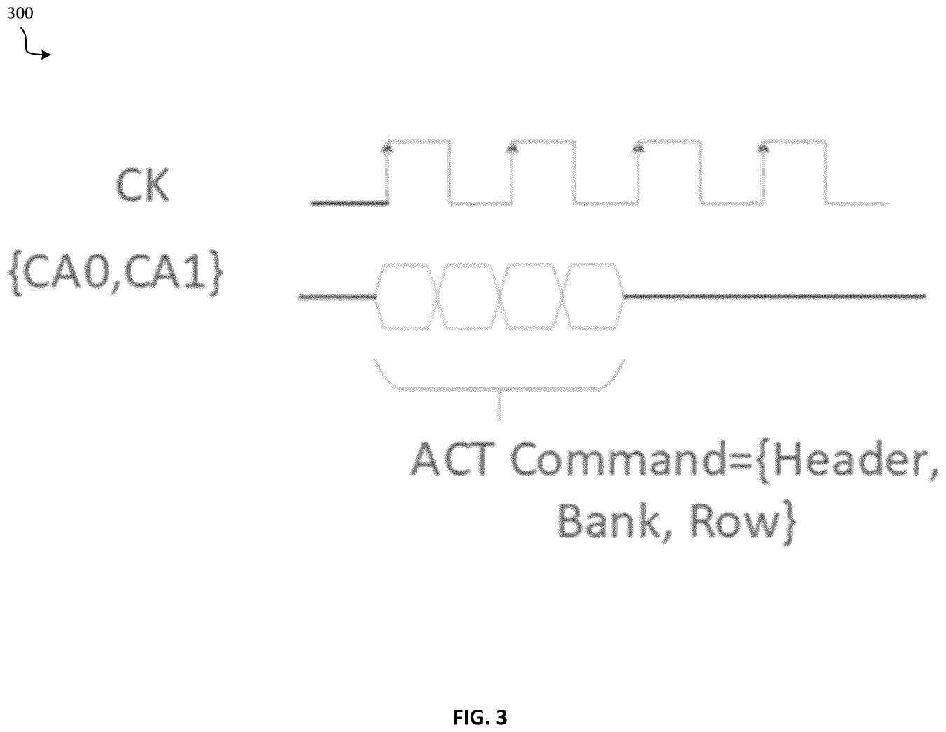

FIG. 3 depicts an example timing diagram for conveying the refresh type flag to a DRAM 104, according to some embodiments. The timing diagram 300 shows that the MCD 102 sends an Activate-1 (ACT-1) command and Activate-2 (ACT-2) command to the DRAM 104 via the command interface (e.g., using CA0 and CA1) and on the rising edge and falling edge of the clock (CK). The MCD 102 may add the refresh type flag to either of these ACT commands (e.g., ACT-1, ACT-2). As shown in FIG. 3, the refresh type flag may be programmed into the header portion of an ACT command. These ACT commands may be used for a 16 bank, 8 bank, or a bank group configuration.

The refresh type flag indicates one of three refresh types/procedures: normal refresh, relaxed refresh, or no refresh. The MCD 102 selects the refresh type based on whether the refresh type would result in the greatest reduction in communication overhead and/or power consumption as compared to the estimated refresh performance of the other refresh types. The MCD 102 may select the particular refresh procedure based on a current memory usage layout of the DRAM 104, the number and/or type of core devices 101 and external devices 203 that are communicating with the DMA controller 208, and/or the type of memory requests sent from the external devices 203 and core devices 101.

The MCD 102 uses 2 bits (each corresponding to a DDR command pin) of an access command to instruct the DRAM 104 as to which refresh type the DRAM 104 should use when performing a row refresh of its data. In some instances, the DRAM 104 may have previously stored a refresh type for performing a row refresh of its data, and if so, then the MCD 102 may decide to use an additional bit (a third bit) to indicate to the DRAM 104 to use the previous refresh type when performing another row refresh of its data. Therefore, according to some embodiments (sometimes referred to as Option 1 method), the MCD 102 could use either 2 bits or 3 bits to instruct the DRAM 104 as to which refresh type should be used when performing a row refresh of its data.

Option 1 method: Activate with refresh control (e.g., CA [2:0] of ACT-2 in Low-Power Double Data Rate 5 (LPDDR5)). Specifically, the MCD 102 sends an ACT-1 command to the DRAM 104 by (1) setting, on the rising edge of the clock, CA0 to CA2 to each be HIGH (e.g., 1) and CA3 to CA6 to be equal to the second portion (e.g., R14, R15, R16, and R17) of the row address, and (2) setting, on the falling edge of the clock, CA0 to CA3 to be equal to the bank address (B16 mode) or bank address and bank group address (BG mode) and CA4 to CA6 to be equal to the first portion (e.g., R11, R12, and R13) of the row address. The MCD 102 sends an ACT-2 command to the DRAM 104 by (1) setting, on the rising edge of the clock, CA0 and CA1 to each be HIGH, CA2 to be LOW (e.g., 0), and CA3 to CA6 to be equal to the second portion (e.g., R7, R8, R9, and R10) of the row address, and (2) setting, on the falling edge of the clock, CA0 to CA6 to be equal to the first portion (e.g., R0, R1, R2, R3, R4, R5, and R6) of the row address.

Thus, the MCD 102 may embed the refresh type flag into an activation command by using 2 bits/pins of the DDR command interface (e.g., links 106, 108 in FIG. 1). Alternatively, the MCD 102 may embed the refresh type flag into an activation command by using 3 bits/pins of the DDR command interface when instructing the DRAM 104 to use a previously stored refresh type. In either embodiment, a memory designer does not have to add extra pins to the DRAM 104 to be able to support the Option 1 method.

For example, the MCD 102 may issue an ACT-1 command and an ACT-2 command next to each other, thereby making a 4 unit interval (UI) command. Then, the ACT-2 header (3-bits) can be used to deliver 3-bit refresh type flag. If data is sent at the rising edge and falling edge of a clock, then 1 UI of the data is a half period of the clock.

As another example, the MCD 102 may issue a command starting with an “LLL” header to indicate the refresh type of the previous ACT command. Since the command bandwidth is not 100% utilized, the impact of adding one more command would not affect the overall performance.

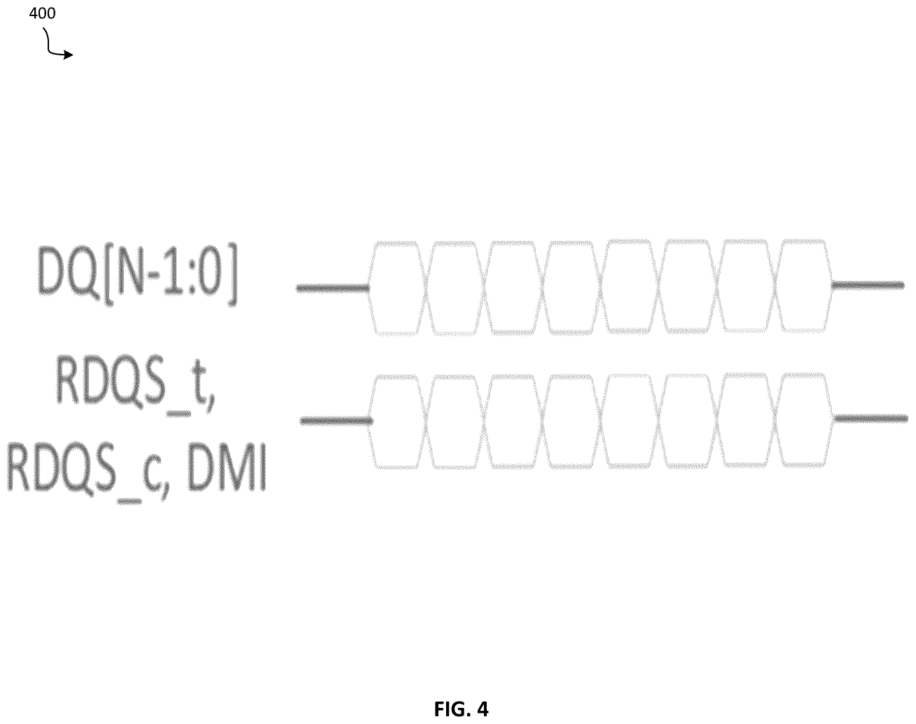

Option 2 method: FIG. 4 depicts an example timing diagram for conveying the refresh type flag to the DRAM 104 when sending write data, according to some embodiments. The timing diagram 400 shows that 3 pins/inputs (e.g., DMI [1:0], RDQS_t, and RDQS_c) may be used to convey the refresh type flag to the DRAM 104. These 3 pins/inputs may be used during any of the timeslots when they are unused for other purposes. Their availability depends on the MR20 bit assignment (e.g., 01, 11, or 10), whether the RDQS pin is single-ended or differential, and whether link protection is enabled or disabled. Therefore, according to some embodiments (sometimes referred to as the Option 2 method), the MCD 102 could use one or more of these pins to instruct the DRAM 104 as to which refresh type should be used when performing a row refresh of its data. In some embodiments, the WRITE command does not use all of 3 pins/inputs (e.g., DMI [1:0], RDQS_t, and RDQS_c). In some embodiments, the refresh type flag can be programmed into unused pins.

Write w/refresh control (e.g., encoding in DMI [1:0], RDQS_t, and/or RDQS_c in LPDDR5). Specifically, the MCD 102 encodes the refresh type flag into the signals sent to the DRAM 104 via one or more of the 3 pins/inputs (e.g., DMI [1:0], RDQS_t, and RDQS_c). Furthermore, because the MCD 102 sends the write data to the DRAM 104 using relatively long burst times, the MCD 102 is able to send the refresh type flag to the DRAM 104 via one or more of the 3 pins during the burst time (e.g., burst duration, transmission duration) of the burst of data. That is, the MCD 102 sends the write data to the DRAM 104 using the data interface (e.g., DQ 114, DQ124) and command interface (e.g., CA 116, CA 126), and within the same time window and in parallel, the MCD 102 also sends the refresh type flag to the DRAM 104 on one or more of the 3 pins (e.g., DMI [1:0], RDQS) within the same time window and in parallel. Thus, the Option 2 method has the advantage of reducing the communication overhead on links 106, 108, reducing the overall power consumption of the MMS 206 and/or the DRAM 104, and reducing system delay.

In other words, the MCD 102 periodically sends refresh commands to the DRAM 104 in order to retain the state of the memory cells in an addressed bank (or pair of banks in BG or 16 Bank mode) or all banks. Upon receiving the refresh command, the DRAM 104 performs the refresh operation on a row or rows addressed by an internally generated row refresh address counter. The information conveyed by either the Option 1 or Option 2 methods enable reduction in power by not energizing (e.g., activating and pre-charging) rows whose applications do not require long-term retention or can tolerate a higher error rate (e.g., due to relaxed refresh timing). Consequently, as the information is conveyed during existing memory access commands or write, no additional command bandwidth is required.

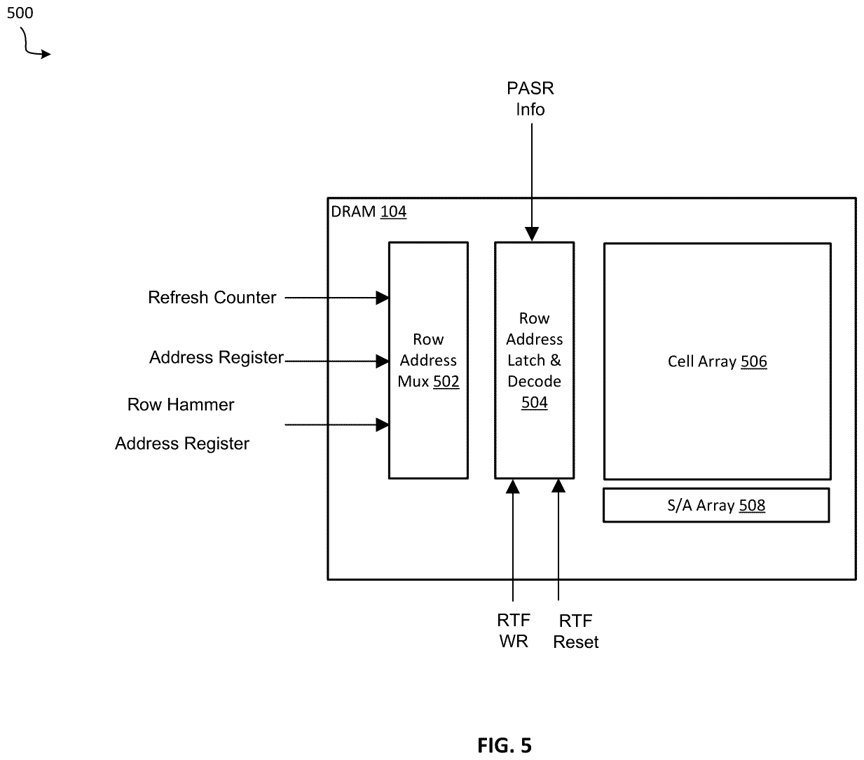

FIG. 5 illustrates a block diagram of an example of the DRAM in FIG. 1, according to some embodiments. The DRAM 104 may include a row address mux 502, a cell array 506 (an array of memory cells for storing data), and a sense amplifier (S/A) array 508. The DRAM 104 also includes a row address latch & decode 504 for activating a particular row of the cell array 506. As discussed below, the row address latch & decode 504 of DRAM 104 is also configured to store one or more refresh type flags (RTF) for a particular row address. The DRAM 104 has inputs for signals corresponding to a refresh counter, an address register, a row hammer address register (e.g., row hammer control), an RTF write (WR), and RTF reset, and Partial Array Self Refresh (PASR) info bits, each of which may be driven by the MCD 102.

The row address mux 502 generates a multiplexed signal by multiplexing the refresh counter, an address register (e.g., the row address), and a row hammer address register. The multiplexed signal also indicates the refresh type flag that was selected by the MCD 102 for the corresponding row address and provided to the DRAM 104 by the MCD 102 using either the Option 1 or Option 2 methods, as discussed herein. The row address mux 502 sends the multiplexed signal to the row address latch & decode 504, which then stores the multiplexed signal. The DRAM 104 may be configured in self refresh mode or automatic refresh mode. In self refresh mode, the clock for the DRAM 104 is deactivated to reduce the power consumption of the DRAM 104 and the DRAM 104 then automatically performs a refresh operation by using its internal refresh counter. Conversely, in automatic refresh mode, the MCD 105 sends a command to trigger the row refresh of the DRAM 104.

Regardless of whether the DRAM 104 is configured in self refresh mode or automatic refresh mode, the DRAM 104 performs the row refresh based on the particular refresh type/procedure that is indicated by the refresh type flag (which is stored in the row address latch & decode 504), the refresh counter, the row hammer address register, and/or the PASR info bits.

The row address latch & decode includes a refresh control circuitry that may have one of three implementations (e.g., refresh type flag per Word Line (WL), a refresh type flag per main WL, or a refresh type flag per mat (MAT) row), each resulting in a different hardware (latches) overhead. Specifically, the refresh type flag per WL implementation produces the finest granularity of the 3 implementations but demands the most complex circuitry because there are 2 (or 3) bits (e.g., latches) per row and the gating row activation is from refresh control. The refresh type flag per main WL implementation reduces the number of latches by ⅛ or by the inverse of the number of sub WLs per a main WL. The refresh type flag per MAT implementation reduces the number of latches by 1/N, where N=number of rows per MAT.

Prior to sending the refresh type flag to the DRAM 104, the MCD 102 initializes the latches of the DRAM 104 to a default value. The initialization values of the latches may be configurable.

The overriding rule (sometimes referred to as overloading rule) may be applied in updating the latches and the overriding rule may be configurable. If the DRAM 104 has a first refresh type in the latches for a row and receives a request of a second refresh type for the row, the DRAM 104 applies the overriding rule in updating the latches. For example, if the first refresh type is normal refresh and the second refresh type is no refresh, the DRAM 104 does not update the latches.

On power-up, the DRAM 104 resets the refresh type flag. The MCD 102 may reset the refresh type flag by sending an MRS command (e.g., PASR setting) to the DRAM 104. The MCD 102 may, in some embodiments, reset the refresh type flag by sending a separate command (e.g., a mode register write command) to the DRAM 104.

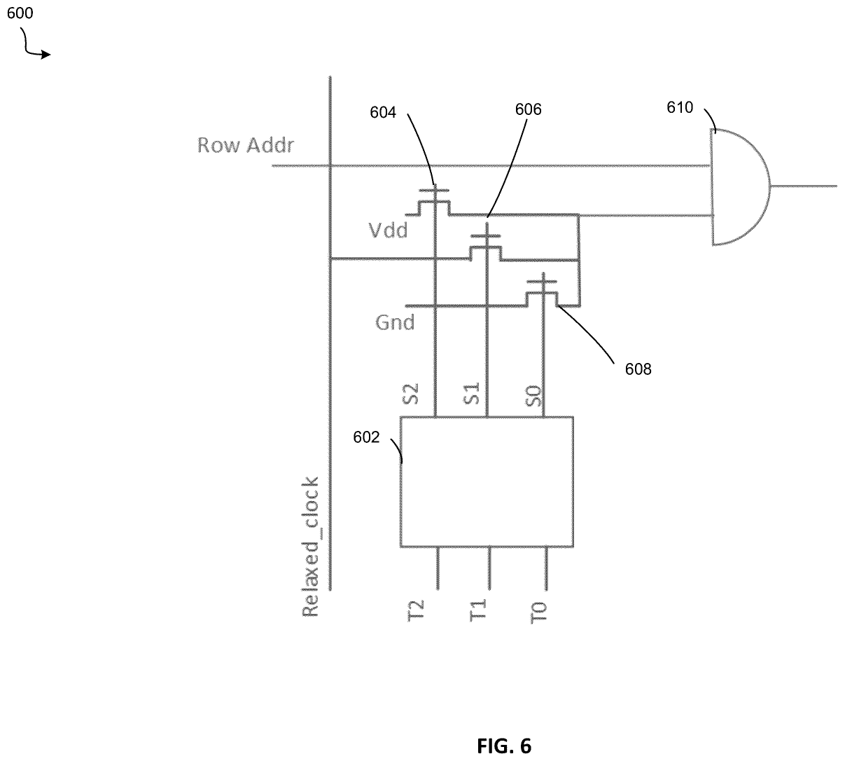

FIG. 6 illustrates a block diagram of a local refresh control circuitry of the row address latch & decode of the DRAM in FIG. 1, according to some embodiments. That is, the local refresh control circuitry 600 is configured to determine, based at least in part on the refresh type flag, whether to prevent a row refresh command from causing a refresh of the DRAM 104 by gating the refresh type flag and not letting it arrive at the cell array 506.

The local refresh control circuitry 600 includes a device 602, transistor 604, transistor 606, transistor 608, and an AND gate 610. The device 602 receives input signals T2, T1, T0. The device 602 generates, based on the input signals, local control signals S2, S1, S0 whose combination represents a particular internal state (e.g., normal refresh, relaxed refresh, or no refresh) of the refresh type flag. The mapping between these three states (e.g., normal refresh, relaxed refresh, and no refresh) and the local control signals S2, S1, S1 are globally programmable by the MCD 102. The local refresh control circuitry 600 implements an overriding rule of S2>S1>S0.

An example logic implementation is as follows:
always @( . . . ) begin
S2<=S2|T2;
S0<=S0 & T0;
end
S1=˜S2 &˜S0

Thus, the local refresh control circuitry 600 determines whether to perform a row refresh corresponding to a row address based on the relaxed_clock, the input signals T2, T1, T0, and the local control signals S2, S1, S0. The role of relaxed_clock is to gate (e.g., block) refresh operation every other time or even more, and the signal is generated per-bank level or globally.

A programming model may be created to support the present embodiments. The programming model may include one or more Application Programming Interfaces (APIs) that are configured to include one more parameter specifying refresh type.

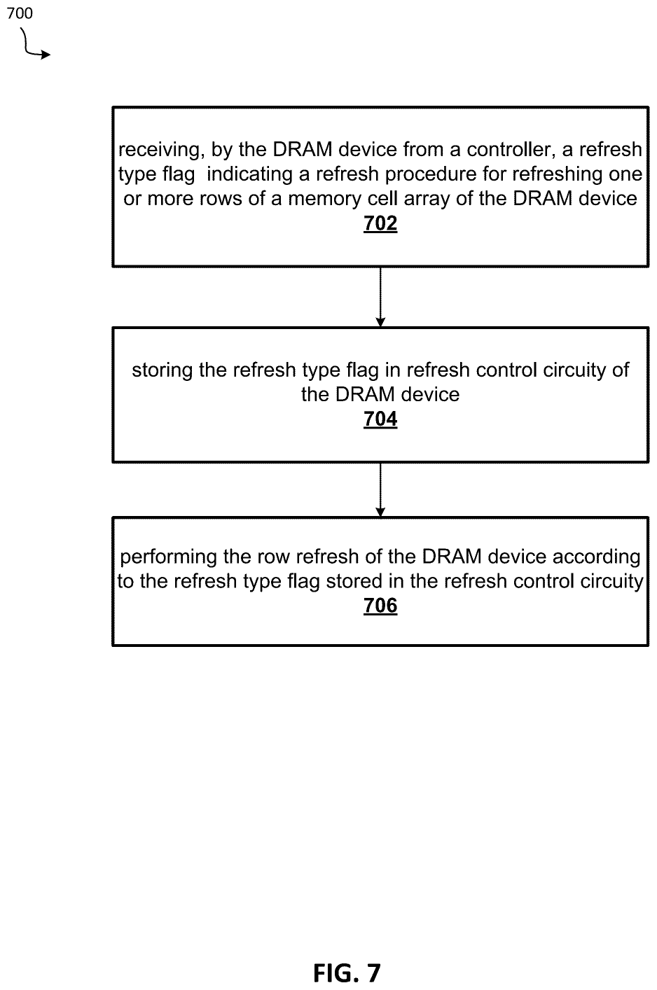

FIG. 7 is a flow diagram depicting a method for managing data refresh of a memory device per access-granularity to reduce the communication overhead and/or overall power consumption of the memory device, according to some embodiments. Method 700 may be performed by processing logic that may include hardware (e.g., circuitry, dedicated logic, programmable logic, a processor, a processing device, a central processing unit (CPU), a system-on-chip (SoC), etc.), software (e.g., instructions running/executing on a processing device), firmware (e.g., microcode), or a combination thereof. In some embodiments, method 700 may be performed by a memory system, such as memory system 100 in FIG. 1. In some embodiments, method 700 may be performed by a memory management system, such as MMS 206 in FIG. 2.

With reference to FIG. 7, method 700 illustrates example functions used by various embodiments. Although specific function blocks (“blocks”) are disclosed in method 700, such blocks are examples. That is, embodiments are well suited to performing various other blocks or variations of the blocks recited in method 700. It is appreciated that the blocks in method 700 may be performed in an order different than presented, and that not all of the blocks in method 700 may be performed.

As shown in FIG. 7, the method 700 includes the block 702 of receiving, by the DRAM device from a controller, a refresh type flag indicating a refresh procedure for refreshing one or more rows of a memory cell array of the DRAM device. The method 700 includes the block 704 of storing the refresh type flag in refresh control circuitry of the DRAM device. The method 700 includes the block 706 of performing the row refresh of the DRAM device according to the refresh type flag stored in the refresh control circuitry.

Unless specifically stated otherwise, terms such as “receiving,” “storing,” “performing,” “executing,” “initializing,” “gating,” or the like, refer to actions and processes performed or implemented by computing devices that manipulates and transforms data represented as physical (electronic) quantities within the computing device's registers and memories into other data similarly represented as physical quantities within the computing device memories or registers or other such information storage, transmission or display devices. Also, the terms “first,” “second,” “third,” “fourth,” etc., as used herein are meant as labels to distinguish among different elements and may not necessarily have an ordinal meaning according to their numerical designation.

Examples described herein also relate to an apparatus for performing the operations described herein. This apparatus may be specially constructed for the required purposes, or it may include a general purpose computing device selectively programmed by a computer program stored in the computing device. Such a computer program may be stored in a computer-readable non-transitory storage medium.

The methods and illustrative examples described herein are not inherently related to any particular computer or other apparatus. Various general purpose systems may be used in accordance with the teachings described herein, or it may prove convenient to construct more specialized apparatus to perform the required method steps. The required structure for a variety of these systems will appear as set forth in the description above.

The above description is intended to be illustrative, and not restrictive. Although the present disclosure has been described with references to specific illustrative examples, it will be recognized that the present disclosure is not limited to the examples described. The scope of the disclosure should be determined with reference to the following claims, along with the full scope of equivalents to which the claims are entitled.

As used herein, the singular forms “a”, “an” and “the” are intended to include the plural forms as well, unless the context clearly indicates otherwise. It will be further understood that the terms “comprises”, “comprising”, “includes”, and/or “including”, when used herein, specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular embodiments only and is not intended to be limiting.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Although the method operations were described in a specific order, it should be understood that other operations may be performed in between described operations, described operations may be adjusted so that they occur at slightly different times or the described operations may be distributed in a system which allows the occurrence of the processing operations at various intervals associated with the processing.

Various units, circuits, or other components may be described or claimed as “configured to” or “configurable to” perform a task or tasks. In such contexts, the phrase “configured to” or “configurable to” is used to connote structure by indicating that the units/circuits/components include structure (e.g., circuitry) that performs the task or tasks during operation. As such, the unit/circuit/component can be said to be configured to perform the task, or configurable to perform the task, even when the specified unit/circuit/component is not currently operational (e.g., is not on). The units/circuits/components used with the “configured to” or “configurable to” language include hardware—for example, circuits, memory storing program instructions executable to implement the operation, etc. Reciting that a unit/circuit/component is “configured to” perform one or more tasks, or is “configurable to” perform one or more tasks, is expressly intended not to invoke 35 U.S.C. 112, sixth paragraph, for that unit/circuit/component. Additionally, “configured to” or “configurable to” can include generic structure (e.g., generic circuitry) that is manipulated by software and/or firmware (e.g., an FPGA or a general-purpose processor executing software) to operate in manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks. “Configurable to” is expressly intended not to apply to blank media, an unprogrammed processor or unprogrammed generic computer, or an unprogrammed programmable logic device, programmable gate array, or other unprogrammed device, unless accompanied by programmed media that confers the ability to the unprogrammed device to be configured to perform the disclosed function(s).

The foregoing description, for the purpose of explanation, has been described with reference to specific embodiments. However, the illustrative discussions above are not intended to be exhaustive or to limit the present embodiments to the precise forms disclosed. Many modifications and variations are possible in view of the above teachings. The embodiments were chosen and described in order to best explain the principles of the embodiments and its practical applications, to thereby enable others skilled in the art to best utilize the embodiments and various modifications as may be suited to the particular use contemplated. Accordingly, the present embodiments are to be considered as illustrative and not restrictive, and not to be limited to the details given herein, but may be modified within the scope and equivalents of the appended claims.

What is claimed is:

1. A method of operation in a dynamic random access memory (DRAM) device, the method comprising:
receiving, by the DRAM device from a controller, a refresh type flag indicating a refresh procedure for refreshing one or more rows of a memory cell array of the DRAM device;
storing the refresh type flag in refresh control circuitry of the DRAM device; and
performing the row refresh of the DRAM device according to the refresh type flag stored in the refresh control circuitry.

2. The method of claim 1, wherein receiving the refresh type flag comprises:
receiving a data access command to access a row of the memory cell array of the DRAM device, wherein the data access command includes the refresh type flag.

3. The method of claim 2, wherein the refresh type flag is at least 2 bits of the data access command.

4. The method of claim 1, wherein receiving the refresh type flag comprises:
receiving, via a command interface of the DRAM device, a data access command to access a row of the memory cell array of the DRAM device; and
receiving, during a burst time associated with the data access command, the refresh type flag via one or more inputs of the DRAM device, wherein the one or more inputs are separate from the command interface.

5. The method of claim 4, wherein the one or more inputs of the DRAM device correspond to at least one of a data mask input (DMI) or a read data strobe signal (RDQS).

6. The method of claim 1, wherein the refresh procedure corresponds to a refresh normal procedure, a relaxed refresh procedure, or a no refresh procedure.

7. The method of claim 1, wherein the refresh control circuitry comprises one or more latches, and further comprising:
receiving, from the controller, a command to initialize the one or more latches to a default value; and
initializing the one or more latches to the default value responsive to receiving the command.

8. The method of claim 1, wherein the refresh control circuitry comprises a refresh type flag per Word Line (WL) configuration, a refresh type flag per main WL configuration, or a refresh type flag per matrix row configuration.

9. The method of claim 1, wherein performing the row refresh of the DRAM device according to the refresh type flag stored in the refresh control circuitry is further based on at least one of a refresh counter, a row hammer control, or Partial Array Self Refresh (PASR) bits.

10. The method of claim 1, further comprising:
receiving a refresh command to execute a second row refresh of the DRAM device; and
gating, using the refresh control circuitry, the refresh command to prevent the second row refresh of the memory cell array.

11. A dynamic random access memory (DRAM) device, the DRAM comprising:
a memory cell array;
refresh control circuitry coupled to the memory cell array, and
a command interface to receive, from a controller, a refresh type flag indicating a refresh procedure for refreshing one or more rows of the memory cell array;
wherein the refresh control circuitry is to:
store the refresh type flag in the refresh control circuitry; and
perform the row refresh of the memory cell array according to the refresh type flag stored in the refresh control circuitry.

12. The DRAM device of claim 11, wherein the command interface is further to:
receive a data access command to access a row of the memory cell array, wherein the data access command includes the refresh type flag.

13. The DRAM device of claim 11, wherein the command interface is further to receive a data access command to access a row of the memory cell array, and further comprising:
one or more inputs to receive, from the controller, the refresh type flag during a burst time associated with the data access command, wherein the one or more inputs are separate from the command interface.

14. The DRAM device of claim 13, wherein the one or more inputs correspond to at least one of a data mask input (DMI) or a read data strobe signal (RDQS).

15. The DRAM device of claim 11, wherein the refresh procedure corresponds to a refresh normal procedure, a relaxed refresh procedure, or a no refresh procedure.

16. The DRAM device of claim 11, wherein:
the refresh control circuitry comprises one or more latches;
the command interface is further to receive, from the controller, a command to initialize the one or more latches to a default value; and
the refresh control circuitry is further to initialize the one or more latches to the default value.

17. The DRAM device of claim 11, wherein the refresh control circuitry comprises a refresh type flag per Word Line (WL) configuration, a refresh type flag per main WL configuration, or a refresh type flag per matrix (MAT) row configuration.

18. The DRAM device of claim 11, wherein to the refresh control circuitry is further to perform the row refresh of the memory cell array based on at least one of a refresh counter, a row hammer control, or Partial Array Self Refresh (PASR) bits.

19. The DRAM device of claim 11, wherein:
the command interface is further to receive a refresh command to execute a second row refresh of the memory cell array; and
the refresh control circuitry is further to gate the refresh command to prevent the second row refresh of the memory cell array.

20. A controller integrated circuit (IC) device comprising:
a command interface to couple to a dynamic random access memory (DRAM) device, the command interface to transmit a data access command that specifies an access to a row of the DRAM device;
a circuit coupled to the command interface, the circuit to:
generate a refresh type flag based on a usage of the DRAM device, the refresh type flag indicating a refresh procedure for refreshing the DRAM device; and
an output interface to transmit to the DRAM device, the refresh type flag during a burst time associated with the data access command, wherein the refresh type flag causes the DRAM device to execute a row refresh of the DRAM device according to the refresh procedure.
